(19) United States
(12) Patent Application Publication
(10) Pub. No.: US 2016/0294025 A1
(43) Pub. Date: Oct. 6, 2016

(54) COOLER FOR SECONDARY BATTERY

(71) Applicant: INNOTM USA, INC., Palo Alto, CA (US)

(72) Inventors: Eu Gene CHOI, Palo Alto, CA (US); Yu Chan KONG, Palo Alto, CA (US)

(73) Assignee: INNOTM USA, INC., Palo Alto, CA (US)

(21) Appl. No.: 15/086,436

(22) Filed: Mar. 31, 2016

Related U.S. Application Data
(60) Provisional application No. 62/140,499, filed on Mar. 31, 2015.

(51) Int. Cl. H01M 10/6551; H01M 10/623; H01M 10/6567; H01M 10/6552; H01M 10/6556; H01M 10/613; H01M 10/625

(52) U.S. Cl. CPC H01M 10/6551; H01M 10/613; H01M 10/623; H01M 10/625; H01M 10/6552; H01M 10/6556; H01M 10/6567; H01M 2220/20; H01M 2220/30

(57) ABSTRACT

The present invention relates to a cooler for a secondary battery. The present invention includes: a heat-dissipating member where a battery cell, which generates when power is supplied, or a cell case is mounted; and a backup member supporting and shielding the heat-dissipating member. The heat-dissipating member is a hexahedron having a first surface, a second surface, and a plurality of sides. At least one of the sides of the heat-dissipating member is inclined. The present invention can dissipate heat from a battery cell, using a heat-dissipating member.

### BACKGROUND OF THE INVENTION

1. Field of the Invention

The present invention relates to a cooler for a secondary battery and, more particularly, to a cooler for a secondary battery that cools a battery cell by dissipating heat.

2. Description of the Related Art

In general, secondary batteries include a chargeable/dischargeable battery cell that is used for electronic devices, such as mobile devices and electric vehicles, so the demands for such batteries have increased in recent years. These secondary batteries include plate-shaped or pouch-shaped, or polygonal or circular bar type battery cells.

Secondary batteries use one or two to four battery cells for each small electronic device, but a plurality of battery cells that are unit batteries are manufactured in medium and large battery packs for medium and large devices such as vehicles because they need high power and large capacity.

It is preferable to make medium and large battery packs as small and light as possible, so they may be very densely stacked. Polygonal batteries and pouch type batteries that have small weight to capacity are generally used as battery cells of medium and large battery packs. A nickel-hydrogen secondary battery has been generally used as a unit battery of medium and large battery packs, but recently, a lithium secondary battery having high power to capacity, as in small battery packs, has been studied.

However, when a battery pack using a lithium secondary battery is used for a long period of time, heat is generated by a battery cell, and the internal temperature rapidly increases, particularly, in charging. Such a battery pack reduces the lifespan of a battery cell by increasing in temperature and the efficiency of a battery, and in the worst case, it may burn or explode. Accordingly, such a battery pack necessarily needs a cooling system for cooling the battery cell therein and the cooling system is classified into an air cooling type and a water cooling type.

An air-cooling system, which cools a battery using external air, has the advantage of requiring fewer additional elements because its structure is simple, but the cooling efficiency is not high, so as there is an increase in the number of times of charging/discharging a battery, the battery generates much heat and the system cannot sufficiently cool the battery.

On the other hand, a water-cooling system has high cooling efficiency, but the design is complicated, so it increases too much the entire size of a battery module.

Further, the bar type battery cells described above, as disclosed in Korean Patent Application Publication No. 10-2013-44309 (“Battery module” by Panasonic Ltd.), are usually formed in a cylindrical shape with the width smaller than the length. Those bar type battery cells, as stated in the invention by Panasonic, are vertically inserted into an aluminum case and then received in a box, thereby forming a battery pack or a battery module. The bar type battery cells discharges heat, which is generated in discharging, through a gap inside the case and a discharge passage at the top of the case. Accordingly, bar type battery cells can be cooled by air cooling. However, bar type battery cells are not sufficiently cooled by air cooling when they are overheated by a short circuit, overcharge, or overload.

In order to solve this problem, a flat plate-shaped cooling tube, through which a coolant flows, has been recently developed, and it is disposed between bar type battery cells vertically arranged, as in FIG. 1. That is, the cooling tube is disposed between each cell of a bar type battery. Accordingly, the heat of bar type battery cells is taken by cooling tubes on sides.

However, there is a problem in this case that the entire weight and volume of a battery module are increased too much by the cooling tubes. Further, according to a test by the applicant(s), a bar type battery cell, as shown in FIG. 2, has longitudinal (vertical) thermal conductivity of about 25˜30 W/mK and horizontal thermal conductivity of about 1.5˜2 W/mK, that is, the longitudinal thermal conductivity is far too high. Accordingly, even if a bar type battery cell BC discharges heat to the cooling tube T on its one side, as shown in FIG. 1, the battery cell is not effectively cooled. That is, even though the cooling tube T is disposed on a side of the battery cell, the bar type battery cell BC cannot be sufficiently cooled because it discharges heat further in the longitudinal direction.

Further, the bar type battery cell BC is formed in the shape of a cylinder such as a can, but the cooling tube T is formed in the shape of a flat plate. Accordingly, the cooling tube T is substantially in line contact with the bar type battery cell BC, so it cannot take heat well.

### DOCUMENTS OF RELATED ART

### [Patent Document] Korean Patent Application Publication No. 10-2013-44309

### SUMMARY OF THE INVENTION

An object of the present invention is to provide a cooler for a secondary battery in which a heat-dissipating member equipped with a battery cell or a cell case on a first surface and having a second surface supported and shield by a backup member is formed in a hexahedron having a first surface, a second surface, and a plurality of sides, in which at least one of the sides is linearly or non-linearly inclined such that the first surface and the second surface have different areas.

In particular, another object of the present invention is to provide a cooler for a secondary battery in which an installation area for a battery cell or a cell case, or a heat dissipation area can be increased by making the area of at least one of a first surface and a second surface larger than that of the other one.

Another object of the present invention is to provide a cooler for a secondary battery in which a heat-dissipating member can dissipate heat almost simultaneously with heat generation by a battery cell, a plurality of heat-dissipating members are provided and can simultaneously dissipate heat at several positions, and ends of sides at a first surface or a second surface of a heat-dissipating member is firmly formed.

Another object of the present invention is to provide a cooler for a secondary battery that can prevent discharging of a battery cell by insulating a heat-dissipating member from the battery cell.

Another object of the present invention is to provide a cooler for a secondary battery in which a battery cell can be firmly fixed to a heat-dissipating member and the battery cell can be simply fixed in a bonding type.

Another object of the present invention is to provide a cooler for a secondary battery that includes a heat-dissipating member stably supported and shielded by a backup member, can supply coldness to the heat-dissipating member, and particularly, that can not only cool the heat-dissipating member in a water-cooling type, but supply coldness to several portions of the heat-dissipating member.

Another object of the present invention is to provide a cooler for a secondary battery that includes a medium for transmitting heat to a heat-dissipating member or transmitting heat from the heat-dissipating member to another member.

In order to achieve the above object, according to one aspect of the present invention, there is provided a cooler for a secondary battery that includes: a heat-dissipating member equipped with a battery cell, which generates heat when power is supplied, or a cell case with the battery cell therein, and dissipating heat from the battery cell to the outside or transmitting the heat to another member; and a backup member supporting or shielding the heat-dissipating member.

The heat-dissipating member may have: a first surface where the battery cell or the cell case is mounted; a second surface facing and spaced from the first surface; and a plurality of sides connected to edges of the first surface and the second surface around four sides of the first surface and the second surface.

The first surface and the second surface may have different areas and at least one of the sides around the first surface and the second surface may be linearly or non-linearly inclined.

The heat-dissipating member is formed asymmetrically with respect to a virtual horizontal center line by the inclined sides.

Bar type battery cells of various battery cells are mounted on the heat-dissipating member.

The heat-dissipating member may be equipped with battery cells on a second surface and may dissipate heat from the battery cells transmitted to the first surface and the second surface.

The sides of the heat-dissipating member may be non-linearly curved convexly or concavely or with prominences and depressions, or linearly formed.

Sides at both ends of the sides of the heat-dissipating member may be inclined such that the both ends are symmetrically formed.

The heat-dissipating member may be a heat pipe that is a hollow container sealed at four sides by the first surface, the second surface, and the inclined sides and filled with working fluid for diffusing and dissipating heat from the battery cell by circulating therein by heat from the battery cell.

In particular, the heat-dissipating member may be at least one of a flat heat pipe or a heat pipe having a substantially elliptical cross-section.

The heat-dissipating member may be a thermally conductive metallic plate or block, or a cooling tube or a water jacket keeping cooling water therein, unlike the above description.

The heat-dissipating pipe has a trapezoidal or inverse trapezoidal cross-section in which the first surface and the second surface have different areas.

The heat-dissipating member may be a heat pipe unit including a plurality of heat pipes arranged in parallel with each other.

The heat-dissipating member may be formed by arranging the heat pipes in close contact with each other or at a predetermined distance from each other and in parallel with each other in a row.

The heat-dissipating member may have a curl at at least one of both ends of the sides at the edges of the second surface or the first surface.

The heat dissipating member may further include an insulating layer made of an insulating material to insulate an end of the battery cell or the cell case from the first surface.

The insulating layer may be made of paint containing a thermally conductive material.

The cooler may further include a fastener connecting the battery cell or the cell case to the heat-dissipating member by fixing the battery cell or the cell case to a side of the heat-dissipating member.

The fastener may be a binder attaching a portion of the battery cell or the cell case to a side of the heat-dissipating member.

The binder may be an adhesive or a bond containing a thermally conductive material.

The backup member may be a tray having a seat for the heat-dissipating member.

The cooler may further include a chiller cooling the heat-dissipating member by supplying coldness to at least one side of the heat-dissipating member.

The chiller may be a tube-typed water jacket through which a coolant for supplying coldness to the heat-dissipating member flows.

The chiller may be connected directly to the heat-dissipating member and supply coldness directly to the heat-dissipating member, or may be attached to a thermally conductive member such as a heat sink or a heat-dissipating angle bar on the heat-dissipating member and supply coldness to the heat-dissipating member through the thermally conductive member.

The chiller may include: a first chiller disposed on a side of the heat-dissipating member; and a second chiller disposed in parallel with the first chiller on the side of the heat-dissipating member.

The cooler may further include a heat-dissipating channel that is a space defined between the first chiller and the second chiller, when the first chiller and the second chiller are spaced from each other.

The chiller may be attached to the heat-dissipating member by the binder or the insulating layer.

According to the present invention, since the heat-dissipating member has inclined sides, the areas of the first surface and the second surface of the heat-dissipating member can be made different and accordingly the installation area or the heat dissipation area of the battery cell or the cell case can be increased; therefore, it is possible to easily install a battery cell or a cell case, or easily dissipate heat from a battery cell. Further, since the heat-dissipating member is supported and shielded by a backup member, the heat-dissipating member can be easily mounted on an apparatus such as an electric vehicle or can be protected from foreign substances.

In particular, the sides are linearly or non-linearly formed, the heat-dissipating member can be manufactured in various structures in accordance with the structure or the required heat dissipation ability of a battery cell. Further, when non-linearly inclined surfaces are formed in a curved or a zigzag (prominence-depression) shape, the sides of the heat-dissipating member can be curved, so it is possible to substantially increase the areas of the sides of the heat-dissipating member, whereas if the inclined sides are linearly formed, the sides of the heat-dissipating member are simply orthogonally formed, so manufacturing becomes more convenient.

Since the heat-dissipating member may be a heat pipe and can quickly dissipate heat from a battery cell, it is possible to most effectively prevent overheating of the battery cell. Further, since a bar type battery cell is mounted on the first surface, it is possible to quickly absorb and dissipate heat from the longitudinal end of the bar type battery cell. Further, since a heat pipe has a trapezoidal or an inverse trapezoidal cross-section by the inclined sides, it is possible to install and fix the heat pipe to be suitable for the place where the heat pipe is installed. Further, since a plurality of provided in a single unit, it is possible to simultaneously dissipate heat at several positions, and accordingly, it is possible to improve heat dissipation efficiency and combine the heat pipe to be suitable for battery cells or the place where the heat pipes is installed.

Further, since the sides of the heat-dissipating member are curled, it is possible to increase strength at the ends of the sides. Further, since an insulating layer is provided, it is possible to prevent discharging of a battery cell using the heat-dissipating member and to prevent a safety accident due to an electric shock. In particular, when the insulating layer contains a thermally conductive material, the insulating layer functions as an insulating and thermally conductive medium, so it is possible to insulate the battery cell and smoothly transmit heat from the battery cell to the heat-dissipating member.

Further, since a battery cell or a cell case is fixed to the heat-dissipating member by a fastener, it is possible to substantially directly transmit heat from the battery cell to the heat-dissipating member. Further, when the fastener is a binder attaching a battery cell or a cell case to the heat-dissipating member, it is possible to easily fix the battery cell or the cell case to the heat-dissipating member, so manufacturing can be more convenient. In particular, when the binder contains a thermally conductive material, the binder functions as a thermally conductive medium, so it is possible to smoothly guide heat from the battery cell to the heat-dissipating member.

Further, when the backup member is a tray with a seat, the heat-dissipating member can be received in the seat, so it is possible to prevent movement of the heat-dissipating member and the heat-dissipating member can be easily mounted on an apparatus such as an electric vehicle through the tray.

Further, when a chiller is provided, it is possible to quickly cool the heat-dissipating member using the coldness from the chiller. Further, when the chiller is a water jacket, it is possible to cool the heat-dissipating member in a water-cooling type, so it is possible to improve cooling efficiency of the heat-dissipating member. Further, when a plurality of chillers is provided, coldness is supplied to the heat-dissipating member from the chillers, so the cooling efficiency of the heat-dissipating member can be further improved.

Further, when the chiller indirectly supplies the coldness to the heat-dissipating member through a thermally conductive member such as a common heat-dissipating angle bar or a heat sink that is brought in contact with the entire first surface or second surface of the heat-dissipating member or directly supplies the coldness through the binder or the insulating layer containing a thermally conductive material, it is possible to easily supply the coldness to the entire heat-dissipating member.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a side view of common bar type battery cell and cooling tube;

FIG. 2 is a view showing heat generation by the bar type battery cell shown in FIG. 1;

FIG. 3 is a perspective view of a cooler for a secondary battery according to an embodiment of the present invention;

FIG. 4 is a vertical cross-sectional view of the cooler for a secondary battery shown in FIG. 3;

FIG. 5 is a front view showing another embodiment of the cooler for a secondary battery shown in FIG. 3;

FIG. 6 is a vertical cross-sectional view showing the heat-dissipating member shown in FIG. 5 equipped with a heat-dissipating member.

FIG. 7 is a perspective view showing the heat-dissipating member shown in FIG. 3 equipped with a chiller;

FIGS. 8A and 8B are front views of FIG. 7;

FIG. 9 is a plan view showing another embodiment of the heat-dissipating member shown in FIG. 7;

FIG. 10 is a conceptual view showing heat dissipation by the heat-dissipating member shown in FIG. 9;

FIGS. 11A and 11B are views showing a process of manufacturing the heat-dissipating member shown in FIG. 3;

FIG. 12 is a perspective view when the heat-dissipating member shown in FIG. 3 has an elliptical cross-section;

FIG. 13 is a cross-sectional view taken along line A-A shown in FIG. 12; and

FIGS. 14A to 14C are views showing a process of manufacturing the heat-dissipating member shown in FIG. 12;

FIGS. 15A and 15B are side views showing another embodiment of the inclined side shown in FIG. 4;

FIG. 16 is a plan view of a unit composed of the heat-dissipating units shown in FIG. 3; and

FIGS. 17A and 17B are side views of the unit shown in FIG. 16.

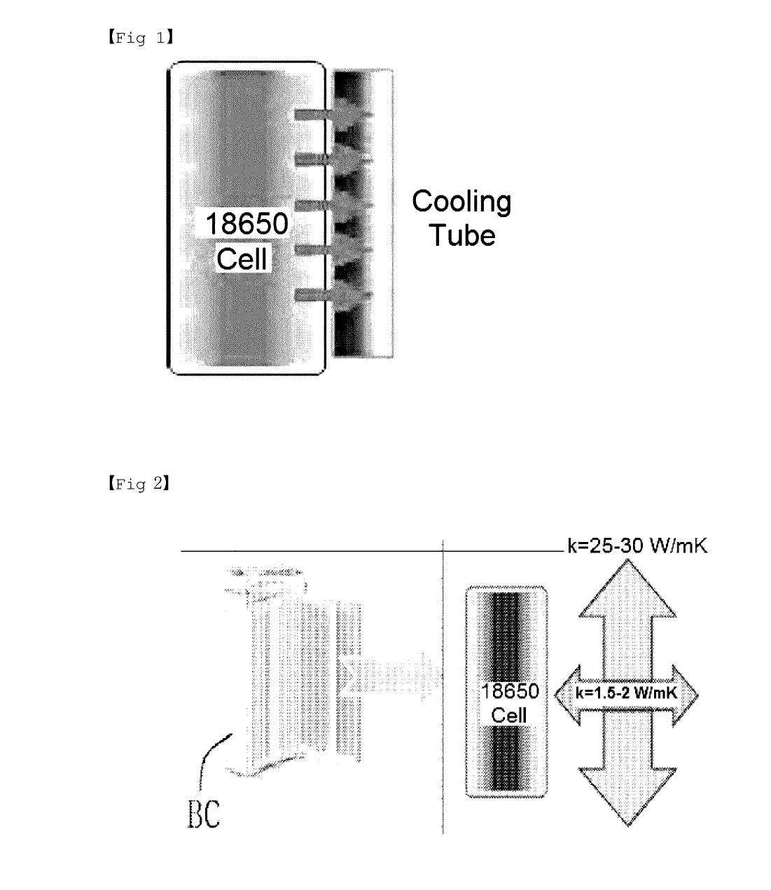

### DETAILED DESCRIPTION OF THE INVENTION

Hereinafter, coolers for a secondary battery according to exemplary embodiments of the present invention will be described with reference to the accompanying drawings.

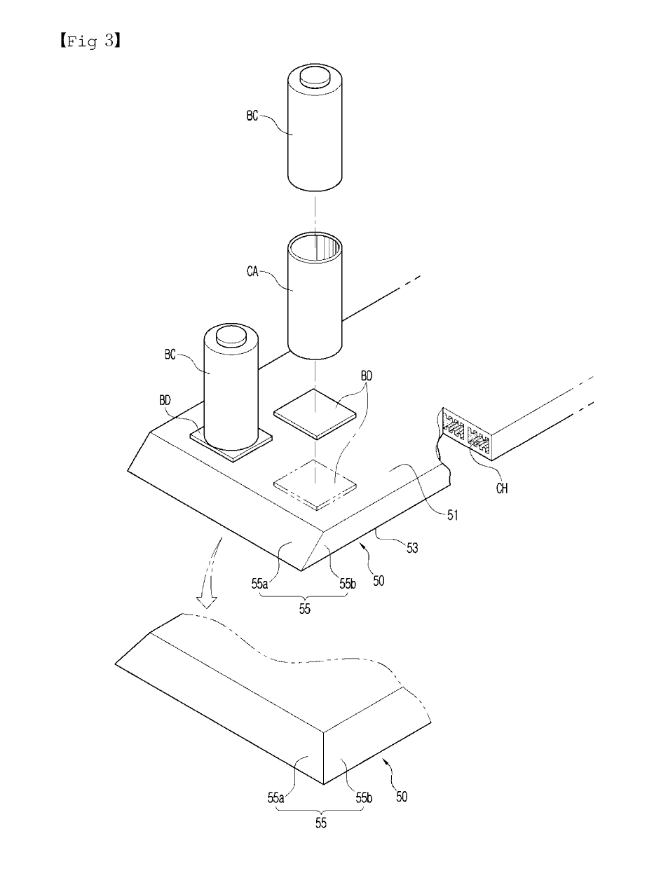

A cooler for a secondary battery according to an embodiment of the present invention includes, as shown in FIG. 3, a heat-dissipating member 50 and a backup member to be described below.

The heat-dissipating unit 50, as shown in FIG. 3, has a battery cell BC or a cell case CA where a battery cell BC is disposed. In the heat-dissipating member 50, as shown in the figure, a cylindrical bar-shaped battery cell BC may be vertically disposed, or a common battery cell (not shown) may be vertically or horizontally disposed.

Heat generated when the battery cell BC is discharged is transmitted to a first surface of the heat-dissipating member 50 and is dissipated through a second surface. For example, when the heat-dissipating member 50 includes a battery cell BC or a cell case CA on the first surface, as shown in the figure, heat is transmitted through the first surface and dissipated through other portions. Accordingly, the heat-dissipating member 50 may be a plate made of a material that can transmit and dissipate heat, a heat pipe to be described below, or a common metallic cooling tube keeping cooling water. When another member made of a conductive material such as a common heat sink or a heat-dissipating angle bar is connected to the first surface of the heat-dissipating member 50, the heat-dissipating member 50 can transmit heat from the battery cell BC to the member.

The heat-dissipating member 50 can directly transmit the heat from the battery cell BC. However, when a cell case CA with a battery cell BC therein is disposed on the first surface of the heat-dissipating member 50, heat from the battery cell BC may be indirectly transmitted through the cell case CA. The side (the bottom in the figure) facing the heat-dissipating member 50 of the cell case CA should be made of a thermally conductive material.

The heat-dissipating member 50, as shown in FIG. 3, has a top 51, a bottom 53, and a plurality of sides 55, which form a hexahedron. A battery cell BC or a cell case CA may be directly disposed on the top 51, as shown in the figure, or may be indirectly disposed through a binder BD shown in the figure or an insulating layer IL to be described below. When the battery cell BC generates heat, the top 51 transmits the heat to the bottom 53 or the sides 55, which will be described below.

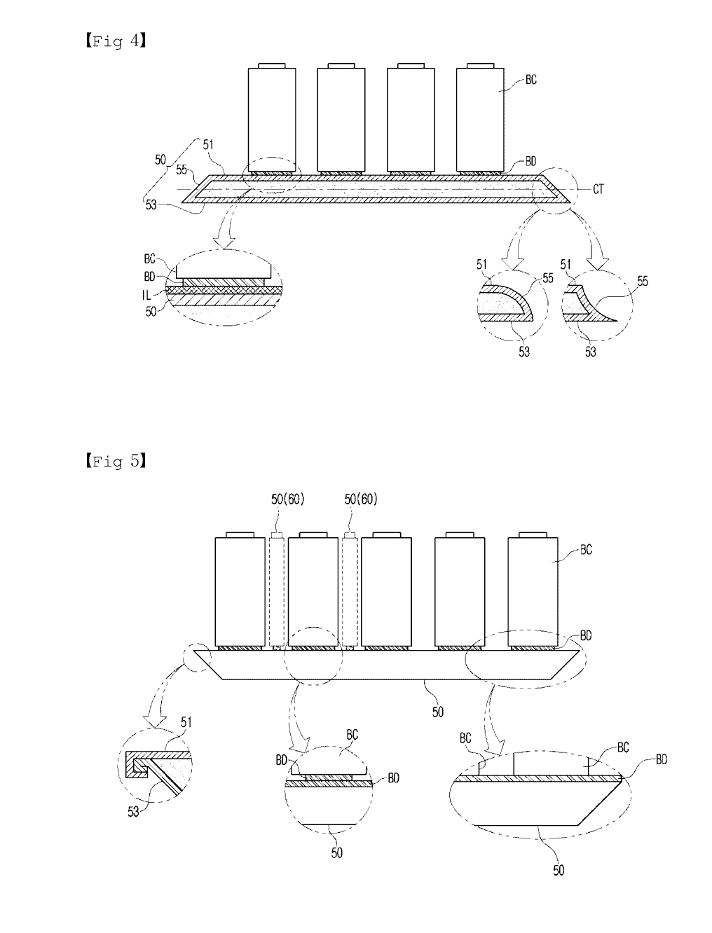

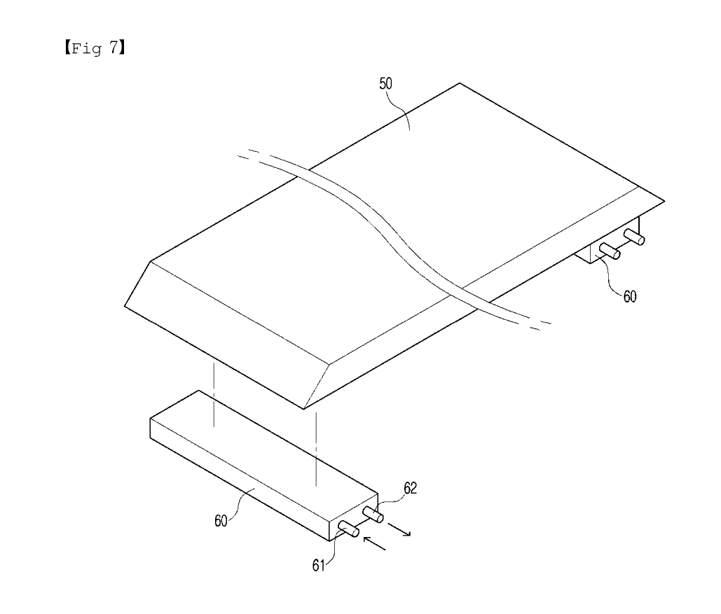

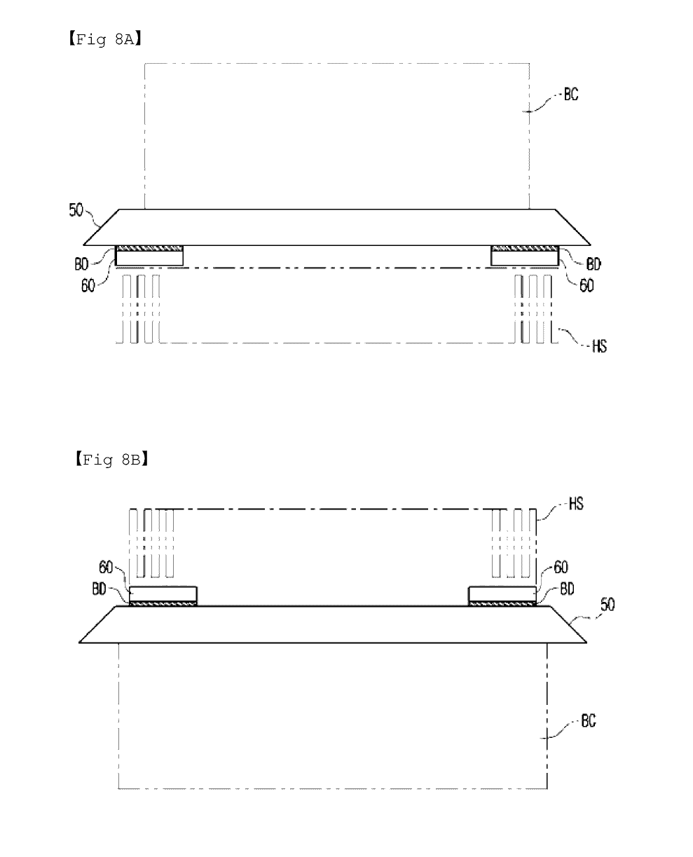

The bottom 53 faces and is spaced from the top 51, as shown in FIG. 4. The battery cell BC or the cell case CA with a battery cell BC therein may be disposed on the bottom 53, as shown in FIG. 8B. Accordingly, the bottom 53 transmits heat from the battery cell BC to the top 51 or the sides 55 to be described below. The bottom 53 and the top 51 have different areas, as shown in FIG. 4.

The sides 55, as shown in FIG. 4, are connected at both ends (upper ends and lower end) to the edges of the top 51 and the bottom 53 around four sides of the top 51 and the bottom 53. That is, the sides 55 are formed along the edges of the top 51 or the bottom 53 in the same number as the number of the edges. The sides 55, as shown in FIGS. 3 and 4, may be composed of inclined sides 55a formed at an angle with respect to the top 51 and the bottom 53 and vertical sides 55b vertically formed.

The inclined sides 55a, as shown in FIG. 4, may be formed in a line shape formed in a straight line and making a diagonal line. However, the inclined sides 55a, shown as being enlarged in FIG. 4, may be formed in a non-linear shape that is concavely or convexly curved or has a zigzag shape (prominences and depressions) at an angle.

The heat-dissipating member 50, as shown in FIG. 3, may have the inclined side 55a at only one of both ends (front end and rear end), may have inclined sides 55a only at both sides, shown as being enlarged in FIG. 3, or may have inclined sides 55a at all of the four sides. The heat-dissipating member 50, as shown in FIG. 4, may have inclined sides 55a at both ends such that both ends have a symmetric relationship. In this case, any one of the top 51 and the bottom 53 of the heat-dissipating member 50, as shown in the figure, is smaller than the other one.

The heat-dissipating member 50 may be a plate (heat-dissipating plate) or a block (heat-dissipating block) made of conductive metal, or a common heat-dissipating angle bar formed by a rectangular hollow pipe, or a common cooling tube that keeps cooling water. However, the heat-dissipating member 50, as shown in FIG. 4, may be a heat pipe that is a hollow container with four sides sealed by the top 51, the bottom 53, and the sides 55, and filled with working fluid. Accordingly, working fluid is evaporated and condensed in the heat-dissipating member 50 by heat from the battery cell BC, thereby spreading and dissipating the heat from the battery cell BC.

The heat-dissipating angle bar or the cooling tube can be easily understood by those skilled in the art, so they are not described in detail herein.

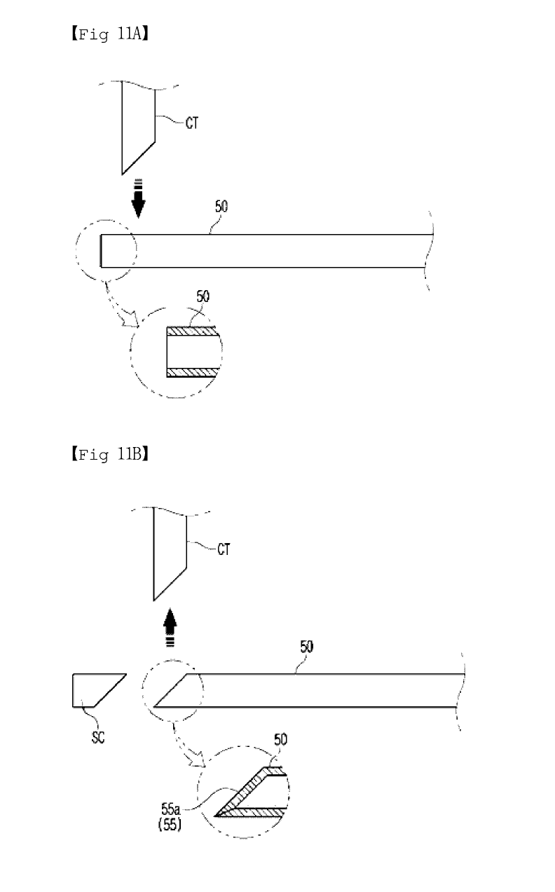

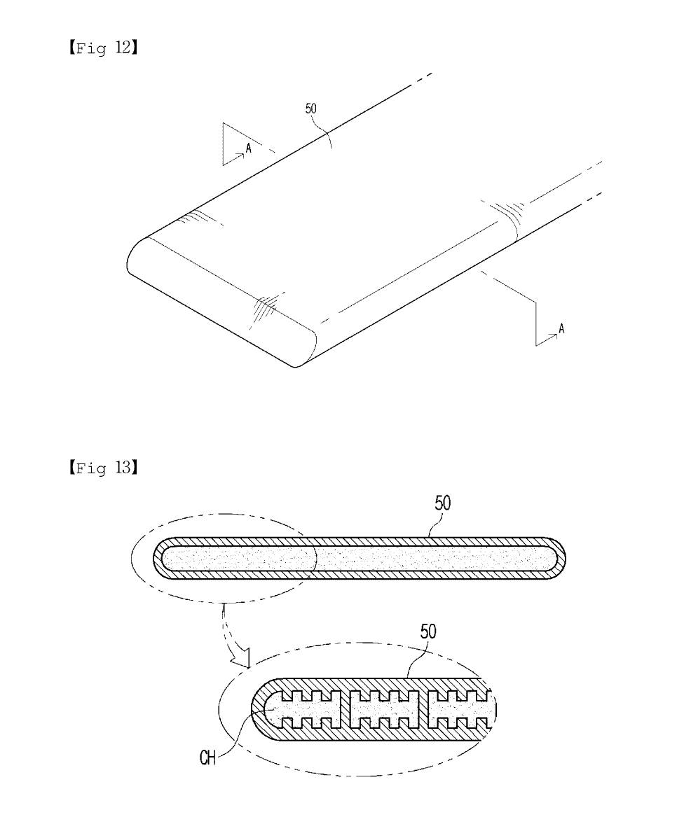

The heat-dissipating member 50 may be formed such that the lateral ends have a polygonal (triangular or rectangular) or curved cross-section so that the areas of the lateral ends are substantially increased, as shown in FIGS. 12 and 13, to make a heat pipe having a substantially elliptical structure, but it may be a heat pipe, as shown in FIGS. 3 and 4, for easy extrusion and storage. Further, as shown at the cut portion in FIG. 3, it may be a heat pipe with a plurality of channels CH and/or protruding wicks therein. Further, the heat-dissipating member 50 may be a flat heat pipe formed in the shape of a large plate to mount more battery cells BC, in which the flat heat pipe may substantially have a width of 138 mm to 182 mm and a length of 200 mm to 720 mm. If the width and length of the heat-dissipating member 50 are smaller than those described above, it is difficult to mount a large number of battery cells BC, whereas if the width and length are larger than those, bending may occur, so it is preferable to use a flat heat pipe having the width and length.

In the heat-dissipating member 50 that is the heat pipe, as shown in FIG. 4, the empty inside is asymmetric with respect a virtual horizontal center line CT due to the inclined sides 55a at both ends. Accordingly, when the top 51 is smaller in area than the bottom 53, as shown in FIG. 4, the heat-dissipating member 50 is formed in a trapezoidal shape, so the inside area increases, as it goes down. However, when the bottom 53 is smaller in area than the top 51, as shown in FIG. 5, the heat-dissipating member 50 is formed in an inverse trapezoidal shape, so the inside area decreases, as it goes up. Therefore, as the inside of the heat-dissipating member 50 increases, a larger space that is filled with working fluid or where working fluid circulates is achieved, so heat dissipation ability is improved.

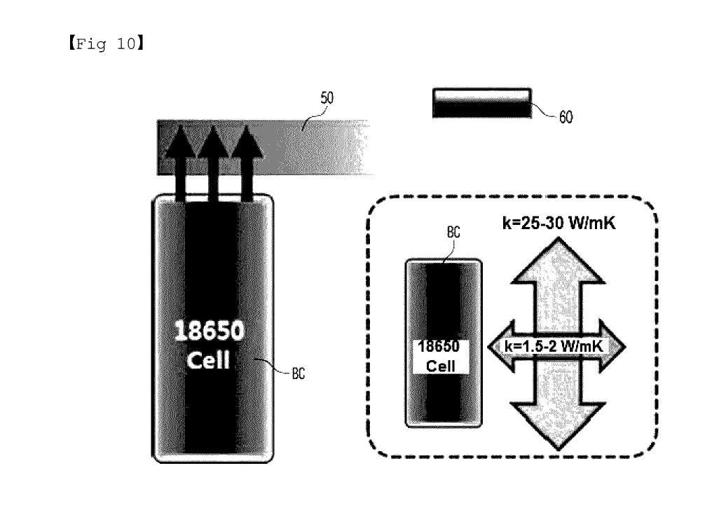

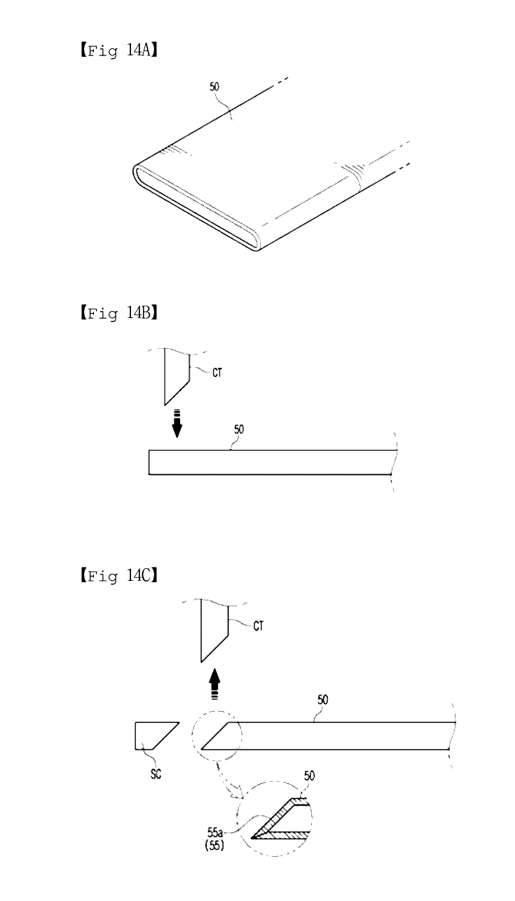

The heat-dissipating member 50 that is the heat pipe described above is, for example, extruded into a rectangular flat hollow tube, as shown at the cut portion in FIG. 3, and then cut by a pinch cutter T of which one or both ends are inclined, as shown in FIGS. 11A and 11B, thereby forming the inclined side 55a. In the extruded hollow tube, a first end is first formed into the inclined side 55a and then sealed, work fluid is supplied through a second end, and then the second end is formed into the inclined side 55a and sealed, whereby the inclined sides 55a are formed at both ends. Alternatively, the heat-dissipating member 50, shown as being enlarged in FIG. 3, may be extruded into a hollow trapezoidal tube and then inclined sides 55a are formed in the was described above, whereby inclined sides 55a may be formed at both sides. However, in the heat-dissipating member 50, only any one of both sides may be finished as an inclined side 55a and the other one may be finished as a non-inclined side 55a such as the vertical side 55b. Further, the heat-dissipating member 50 may be extruded into a flat hollow tube having a substantially elliptical cross-section, as shown in FIGS. 12 and 13, and then the ends of the hollow tube may be sealed in the way described above, as shown in FIGS. 14A to 14C. The hollow tube may have the channels CH and protruding wicks in the internal space that is filled with working fluid, as shown in FIG. 13.

The heat-dissipating member 50 may have curl, as shown in FIG. 5, at the ends of the inclined sides 55a formed by the pinch cutter CT. Accordingly, the inclined sides 55a are strongly sealed at the ends.

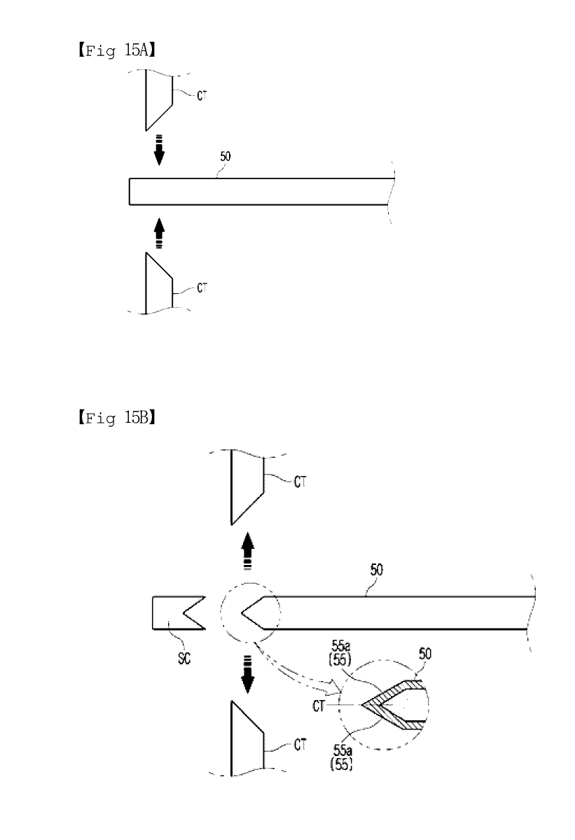

The heat-dissipating member 50 may be cut by the pinch cutter CT at the both sides (upper and lower sides) of the ends, as shown in FIGS. 15A and 15B, so that the inclined sides 55a may be formed at the ends. In the heat-dissipating member 50, shown as being enlarged in FIG. 15B, the inclined sides 55a are symmetrically formed over and under a virtual horizontal center line CT. The end of the heat-dissipating member 50 is formed substantially in a diamond by the pair of symmetric inclined sides 55a, so the area of the end is substantially increased. Accordingly, the heat dissipation ability of the heat-dissipating member 50 is improved by the increased area at the ends.

Battery cells BC or cell cases CA are partially fixed to the heat-dissipating member 50 by fasteners. The fasteners may be binders BD having an adhesive or a viscous bond such as gel or paste, as shown in FIGS. 3 and 4. The binder BD may be a common adhesive or a bond, but may be a material having thermal conductivity and adhesive or bonding ability, for example, a paste type thermal compound made of a thermally conductive material such as a common thermal grease or thermal paste, or a thermally conductive sheet or patch made of a thermally conductive material to be able to be attached. The binder BD may be a sheet or a patch like a soft rubber plate and may be attached to a desired position by its adhesiveness. The binder BD may be an insulating thermal interfacing material containing silicon, thermally conductive elastomer, plastic, or resin as a main part.

The binder BD, as shown in FIGS. 3 and 4, is used to attach a battery cell BC or a cell case CA with a battery cell BC therein to the heat-dissipating member 50. The binder BD may attach only a portion of a battery cell BC or a cell case CA to the heat-dissipating member 50, as shown in the figures, but shown as being enlarged in FIG. 5, it may be applied to the entire surface of the heat-dissipating member 50 where battery cells BC or cell cases CA are attached in order to fix the battery cells BC or the cell cases CA to the heat-dissipating member 50 and transmit heat. Since the binder BD is gel, paste, or a bonding material, a gap is not prevented on the attachment surface of the battery cell BC and the attachment surface of the heat-dissipating member 50 for the characteristics of the soft material. That is, gaps are generated on the attachment surfaces of the battery cell BC and the heat-dissipating member 50, when they are directly attached to each other by processing spread in manufacturing, but the gaps are not generated by the binder BD. Accordingly, the battery cells BC or the cell cases CA are easily mounted on the heat-dissipating member 50 without gap, so heat smoothly transfers to the heat-dissipating member 50 through the binders BD.

The binder BD may be composed of two layers, shown as being enlarged at the center in FIG. 5. The binders BD under the battery cells BC or the cell cases CA are common adhesive or bond, as described above, so they fix the battery cells BC or the cell cases CA to the heat-dissipating member 50. The binders BD applied to the entire surface of the heat-dissipating member 50 contain a thermally conductive material, so they transmit heat from the battery cells BC or the cell cases CA to the heat-dissipating member 50. Both of the two layers of the binders BD may be made of a material containing a thermally conductive material. In this case, the binders BD composed of two layers more smoothly transmit heat from the battery cells BC or the cell cases CA to the heat-dissipating member 50 for the characteristics of the material.

The heat-dissipating member 50 may have an insulating layer IL made of an insulating material, shown as being enlarged in FIG. 4. The insulating layer IL may be made of an adhesive or bonding material such as the binder BD to be attached or bonded to the heat-dissipating member 50, but it may be paint made of an insulating thermal interface material and coated on the heat-dissipating member 50. The insulating layer IL prevents discharging of the battery cells BC by insulating the battery cells BC or the cell cases CA. When a battery cell BC is fixed by a binder BD, as shown in the figures, a gap is prevented on the insulating layer IL by the binder BD.

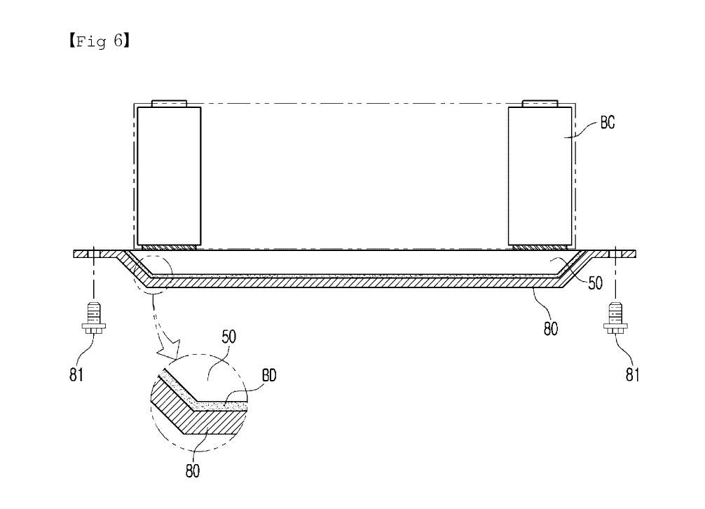

On the other hand, the heat-dissipating member 50 is supported and shielded by a backup member 80, as shown in FIG. 6. The backup member 80, as shown in the figure, is stacked on or overlaps the heat-dissipating member 50, thereby supporting or shielding the heat-dissipating member 50 with the battery cell BC thereon. The backup member 80 can increase strength of the heat-dissipating member 50 by supporting the heat-dissipating member 50 and protects the heat-dissipating member 50 from foreign substances by shielding the heat-dissipating member 50.

When the backup member 80 is made of thermally conductive metal, it can dissipate heat from the heat-dissipating member 50. In particular, when the backup member 80 is used as an encloser with the heat-dissipating member 50 to function as a cover for the bottom of an apparatus such as an electric vehicle (not shown), it can smoothly dissipate heat from the heat-dissipating member 50. That is, the backup member 80 may be used as an encloser for supporting or seating the battery cells BC or the heat-dissipating member 50.

For example, when the backup member 80 is an encloser that is used as a cover coupled to the car body of an electric vehicle, as shown in FIG. 6, it may be used as a tray with a seat for the heat-dissipating member 50. Alternatively, the backup member 80 may be a box-shaped member with an open top for receiving all of the heat-dissipating member 50 and the battery cells BC, or may be a flat plate. Although the heat-dissipating member 50 can be fixed to the backup member 80 in various ways generally known in the art, it is preferable that the heat-dissipating member 50 is fixed by the binder BD, shown as being enlarged in FIG. 6. The backup member 80, as shown in the figures, may be mounted on an apparatus such as an electric vehicle by fasteners such as bolts 81.

According to the embodiment of the present invention described above, as shown in FIG. 4, battery cells BC are mounted on the top 51 of the heat-dissipating member 50 having the inclined sides 55a at least at both sides. That is, the battery cells BC are mounted on the top 51 smaller in area than the bottom 53 of the heat-dissipating member 50. The battery cells BC are strongly fixed to the top 51 of the heat-dissipating member 50 by the binders BD, as shown in the figure. In particular, the battery cells BC are fixed in an insulated state to the surface of the insulating layer IL coated on the heat-dissipating member 50, as shown in the figure. Accordingly, the battery cells BC smoothly transmit heat to the heat-dissipating member 50 through the binders BD and the insulating layer IL in an insulated state.

Since the top 51 where the battery cells BC are mounted is smaller in area than the bottom 53 of the heat-dissipating member 50, as shown in FIG. 4, a small installation area is required, but the bottom 53 is larger in area than the top 51, so the heat dissipation area is substantially increased. Accordingly, the heat dissipation is substantially larger than the heat absorption area in the heat-dissipating member 50, so heat dissipation ability is improved.

Battery cells BC may be mounted on the bottom 53 larger in area than the top 51 of the heat-dissipating member 50, as shown in FIG. 5. In this case, the heat dissipation area is smaller than the heat absorption area in the heat-dissipating member 50, opposite to the above case. However, the installation area for the heat-dissipating member 50 is increased, so more battery cells BC can be installed. Accordingly, the heat-dissipating member 50 can provide more battery cells BC to a space where battery cells BC are supposed to be mounted, for example, a desired space of an electric vehicle.

Further, more battery cells BC than those shown in FIG. 4 can be mounted on the heat-dissipating member 50, so it is possible to satisfy the previous capacity even by reducing the height of the battery cells BC in proportion to the capacity of the increased battery cells BC. Accordingly, it is possible to provide a compact battery module or battery pack through the heat-dissipating member 50.

When the heat-dissipating member 50 is a heat pipe, as shown in FIGS. 3 and 13, heat from a battery cell BC is very smoothly dissipated by working fluid in the heat pipe. Accordingly, the heat-dissipating member 50 prevents deterioration of performance, ignition, and explosion of a battery cell BC by preventing the battery cell BC from overheating. In particular, when the longitudinal ends of the bar type battery cells BC are connected to the heat-dissipating member 50, as shown in FIGS. 4 and 5, it is possible to quickly absorb heat from the bar type battery cells BC and dissipate the heat to the outside, thereby preventing overheating.

On the other hand, the backup member 80, as shown in FIG. 6, prevents the heat-dissipating member 50 with a plurality of battery cells BC thereon from bending by supporting the heat-dissipating member 50 and protects the heat-dissipating member against foreign substances. Since the backup member 80 receives the heat-dissipating member 50 in the seat, as shown in the figure, it stably supports the heat-dissipating member 50. Further, since the heat-dissipating member 50 is fixed by the binders BD, movement of the heat-dissipating member 50 is prevented.

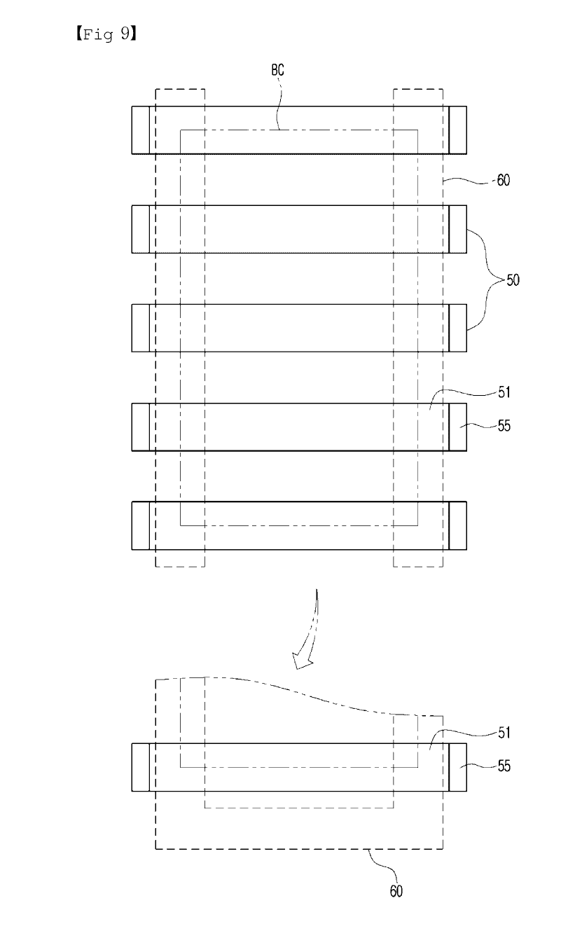

On the other hand, a plurality of heat-dissipating members 50 may be provided in a single unit, as shown in FIG. 9. The heat-dissipating members 50 may be arranged in parallel with each other in a row. The heat-dissipating members 50 may be in contact with each other to exchange heat with each other, as shown in FIG. 16, but may be spaced from each other so that channels for air are formed therebetween to more smoothly dissipate heat, as shown in FIG. 9. When the heat-dissipating members 50 are combined in a single unit, as shown in the figure, they can simultaneously dissipate heat from battery cells BC, so heat dissipation efficiency can be improved. Further, since a plurality of heat-dissipating members 50 is provided, the entire size can be adjusted to be suitable for the number or the positions of battery cells BC. Since a plurality of heat-dissipating members 50 is provided, the entire size is adjusted by increasing/decreasing the number of the heat-dissipating members 50.

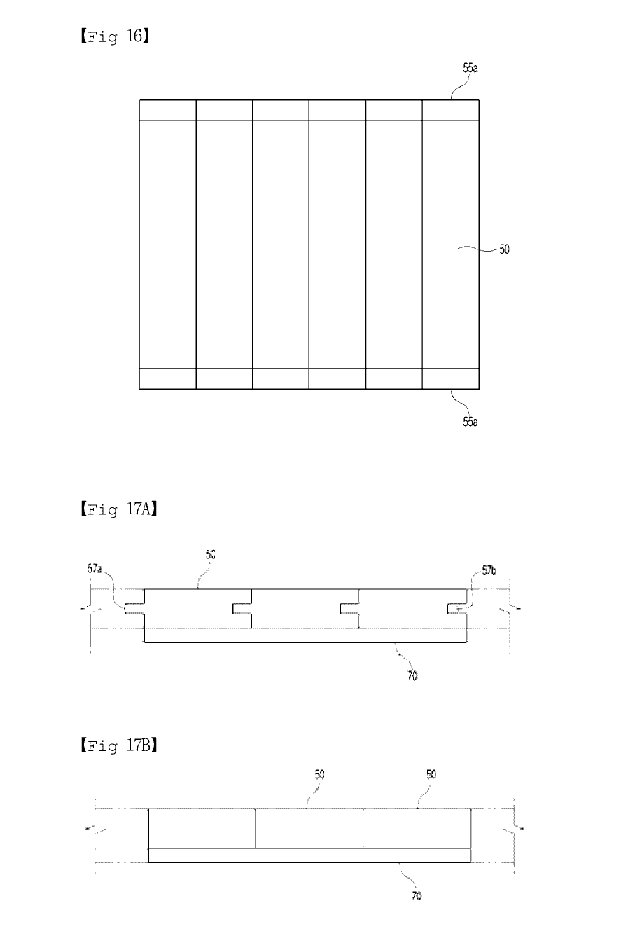

The heat-dissipating members 50 may be coupled to each other by fitting projections 57a and fitting grooves 57b, as shown in FIG. 17A. To this end, a fitting projection 57a is formed on a first side of each of the heat-dissipating members 50 and a fitting groove 57b is formed on a second side so that the heat-dissipating members 50 are combined in a single unit, as shown in the figure. Accordingly, the heat-dissipating members 50 may be extended or expanded to a desired length or size. The heat-dissipating members 50 are supported on the bottoms by a plate-shaped or a bar-shaped reinforcing member 70, as shown in the figure, thereby increasing strength. That is, bending of the heat-dissipating members 50 coupled in a single unit is prevented by the reinforcing member 70. The reinforcing member 70 is the backup member for supporting and shielding the heat-dissipating members 50, can be attached to the heat-dissipating members 50 by the binders BD, or may be attached to the heat-dissipating members 50 by common bolting or welding (soldering). The reinforcing member 70 may be kept in the encloser described above.

Though unlikely, the heat-dissipating members 50 may be coupled in a bonding type, for example, by welding or brazing without the fitting projections 57a and the fitting grooves 57b, as shown in FIG. 17B. When the heat-dissipating members 50 are coupled by welding or brazing, they are firmly coupled and substantially make a single unit. The reinforcing member 70 may be attached to the heat-dissipating members 50 making a single unit to prevent bending, as shown in the figure.

A chiller 60 may be attached to the heat-dissipating member 50, as shown in FIG. 7. The chiller 60 cools the heat-dissipating member 50 by supplying coldness to at least one side of the heat-dissipating member 50. That is, the chiller cools the heat-dissipating member 50 heated by a battery cell BC, as shown in FIG. 10. Accordingly, as the heat-dissipating member 50 is cooled by the chiller 60, it can quickly dissipate heat transmitted through an end of a battery cell BC, as shown in the figure.

The chiller 60, for example, may be a tube-shaped water jacket through which a coolant flows, as shown in the figure. In particular, the chiller 60 may be a flat tube-shaped water jacket so that it can be brought in surface contact with the heat-dissipating member 50.

The chiller 60, as shown in the figure, may have an inlet 61 and an outlet 62 through which a coolant flows inside and outside, and the coolant can be supplied from a common manifold or header for supplying a coolant (not shown) through the inlet and the outlet 62. Accordingly, the coolant circulates through the inlet 61 and the outlet 62 in the chiller 60, so cooing efficiency is improved. However, the chiller 60 may not have the inlet 61 and the outlet 62. In this case, a coolant cools the heat-dissipating member 50 by being circulated in the chiller 60 by heat from the heat-dissipating member 50.

Although the chiller 60 may be attached to the heat-dissipating member 50 in various ways, it is preferable that the chiller is attached to a side of the heat-dissipating member 50 by a binder BD so that the coldness is substantially directly transmitted to the heat-dissipating member 50. Accordingly, the chiller 60 can transmit the coldness to the heat-dissipating member 50 through the binder BD without a gap between the chiller 60 and the heat-dissipating member 50 by the binder BD.

When the heat-dissipating member 50 is equipped with a common flat metal heat-dissipating plate or a heat sink HS having common heat-dissipating fins (not shown), the chiller 60 may be mounted on the heat-dissipating plate or the heat sink HS to be indirectly connected to the heat-dissipating member 50, whereby it can indirectly exchange heat with the heat-dissipating member 50. Further, the chiller 60 may be equipped with an auxiliary heat-dissipating device such as a common heat sink, heat-dissipating plate, or heat-dissipating angle bar (not shown). In this case, the chiller 60 can remove heat from the heat-dissipating member 50 through the auxiliary heat-dissipating device, so the cooling efficiency is further improved. The auxiliary heat-dissipating devices can be easily understood by those skilled in the art, so the detailed description is not provided.

The chiller 60, as shown in FIGS. 8A and 8B, may be mounted on the top 51 of the bottom 53 of the heat-dissipating member 50, depending on the positions of the battery cells BC on the heat-dissipating member 50. Accordingly, the chiller 60 can cool the heat-dissipating member 50 regardless of the positions of the battery cells BC.

The chiller 60 may be arranged at a side of each of the heat-dissipating members 50 in parallel with them, as shown in FIG. 9, but it may be arranged in different direction from the installation direction of the heat-dissipating members 50. Further, one chiller 60 may be provided, but it is preferable that a plurality of chillers 60 is provided to supply much cold, as show in the figures. The chiller 60 may have an area corresponding to the entire area of the heat-dissipating members 50 to smoothly supply the coldness, unlike the figures.

When a plurality of chillers 60 is provided, as shown in FIG. 9, they may be composed of a first chiller on a side of the heat-dissipating member 50 and a second chiller on the other side of the heat-dissipating member 50 in parallel with the first chiller. When a plurality of chillers 60 is provided, they may be in close contact with each other for heat transfer therebetween, but they may be spaced from each other, as shown in the figures. When a plurality of chillers 60 are provided and spaced from each other, heat-dissipating channels that are empty spaces are defined between the chillers 60, as shown in the figures. Accordingly, the chillers 60 can cool a coolant through the heat-dissipating channels.

When a plurality of chillers 60 is provided, shown as being enlarged in FIG. 9, at least predetermined ends of both ends can be connected to each other to make a substantially single unit. In this case, even though a plurality of chillers 60 is provided, they make a single unit, so they can be easily installed.

Flat heat pipes that function as other heat-dissipating members 50 shown by dotted lines in FIG. 5 may be vertically disposed between the battery cells BC or the cell cases CA on the top 51 of the heat-dissipating member 50 shown in FIG. 4. In this case, the heat-dissipating member 50 can dissipate even the heat from the sides of the battery cells BC by the flat heat pipes, so the heat dissipation efficiency is improved. Though unlikely, chillers 60 that function as other heat-dissipating members 50 may be vertically disposed between the battery cells BC on the heat-dissipating member 50. Accordingly, the heat-dissipating member 50 can dissipate even the heat from the sides of the battery cells BC by the chillers between the battery cells BC, so the heat dissipation efficiency is improved.

The embodiments described above are just example of the present invention, so they do not limit the scope of the present invention and may be appropriately modified (in structure or configuration, or partially removed or supplemented) within the scope of the present invention, as long as they satisfy the essential features of the present invention. Further, some or many of the features of the embodiments described above may be combined. Therefore, the structures and configurations of the components in the embodiments of the present invention may be modified and combined, so those modifications and combinations of the structures and configurations should be construed as being included in claims of the present invention.

What is claimed is:

1. A cooler for a secondary battery, comprising:
a heat-dissipating member equipped with a battery cell, which generates heat when power is supplied, or a cell case with the battery cell therein, and dissipating heat from the battery cell to the outside or transmitting the heat to another member; and
a backup member supporting or shielding the heat-dissipating member,
wherein the heat-dissipating member has:
a first surface where the battery cell or the cell case is mounted;
a second surface facing and spaced from the first surface; and
a plurality of sides connected to edges of the first surface and the second surface around four sides of the first surface and the second surface,
wherein the first surface and the second surface have different areas and at least one of the sides around the first surface and the second surface is linearly or non-linearly inclined.

2. The cooler of claim 1, wherein the sides of the heat-dissipating member are non-linearly curved convexly or concavely or with prominences and depressions, or linearly formed.

3. The cooler of claim 1, wherein sides at both ends of the sides of the heat-dissipating member are inclined such that the both ends are symmetrically formed.

4. The cooler of claim 1, wherein the heat-dissipating member is a heat pipe that is a hollow container sealed at four sides by the first surface, the second surface, and the inclined sides and filled with working fluid for diffusing and dissipating heat from the battery cell by circulating therein by heat from the battery cell.

5. The cooler of claim 4, wherein the heat-dissipating member is a heat pipe unit including a plurality of heat pipes arranged in parallel with each other in a row.

6. The cooler of claim 1, wherein the heat-dissipating member has a curl at at least one of both ends of the sides at the edges of the second surface or the first surface.

7. The cooler of claim 1, wherein the heat dissipating member further includes an insulating layer made of an insulating material to insulate an end of the battery cell or the cell case from the first surface.

8. The cooler of claim 1, further comprising a fastener connecting the battery cell or the cell case to the heat-dissipating member by fixing the battery cell or the cell case to a side of the heat-dissipating member.

9. The cooler of claim 8, wherein the fastener is a binder attaching a portion of the battery cell or the cell case to a side of the heat-dissipating member.

10. The cooler of claim 1, wherein the backup member is a tray having a seat for the heat-dissipating member.
